(19) United States
(12) Patent Application Publication
(10) Pub. No.: US 2003/0044231 A1
(43) Pub. Date: Mar. 6, 2003

(54) Puzzle joint system

(76) Inventor: Mark S. Anvick, Mareno Valley, CA (US)

Correspondence Address: Kenneth W. Float, The Law Offices of Kenneth W. Float, P.O. Box 80790, Rancho Santa Margarita, CA, 92688, US

(21) Appl. No.: 09/942,199

(22) Filed: Aug. 29, 2001

(51) Int. Cl. F16B 2/00; F16B 3/00; B25G 3/28; F16B 7/00

(52) U.S. Cl. 403/354

(57) ABSTRACT

A joint system for use in joining components, such as wood, and the like, to form a structural unit. An exemplary joint system has a first member with a predetermined shape, first and second opposed surfaces, and a first predetermined thickness. A cavity is formed in the first member that has an inner contour in the shape of a piece of a puzzle or a molar tooth, for example. The cavity is exposed at the first surface of the first member and along a portion of an edge of the first member. The cavity has a depth that extends a predetermined distance below the first surface of the first member. A second member is provided that has a predetermined shape, first and second opposed surfaces, and a second predetermined thickness. The second member has a tab with an outer contour that substantially matches the inner contour of the cavity in the first member so that the tab fits within the cavity.

### BACKGROUND

The present invention relates generally to joining wood products, and more particularly, to a puzzle joint system for use in joining wood products such as chair and table components, and the like.

In carpentry, a joint is formed at the junction of two or more members of a framed structure. The object of a joint is to fix two members together so that the joint has the greatest possible mechanical strength and is as unobtrusive as possible. Though there are many joints in use, they fall into a few basic groups, and which are variations or elaborations of simple concepts. In general, practically all joints are based on handwork and with few exceptions most machine-made joints have the traditional patterns. Most joints rely involve mechanical fittings and glue for their strength.

Heretofore, wooden components have been joined together using a variety of joints. Common types of joints include a butt joint, a dovetail joint that is used to join two flat members together at right angles, such as the sides of a drawer; a dowelled joint that uses dowels to impart mechanical strength, and a mortise and tenon joint that is used to join a horizontal member with the vertical member of a frame. The present invention provides for an improvement over these conventional joints.

A computer search of the U.S. Patent and Trademark Office patent database revealed five patents having the term “wood joint” in the title, and 35 patents having the term “wood joint” in the specification. Relevant patents having the term “wood joint” in the title include U.S. Pat. No. 5,203,389 entitled “Precision wood-joint making fixture apparatus and method of use with a router”, U.S. Pat. No. 4,734,003 entitled “Wood joint connector plate”, U.S. Pat. No. 4,505,086 entitled “Wood joint cutter and method therefor”, U.S. Pat. No. 4,420,358 entitled “Apparatus for the production of a glued wood joint”, and U.S. Pat. No.4,352,588 entitled “Wood joint”. Relevant patents having the term “wood joint” in the specification include U.S. Pat. No. 5,664,899 entitled “Furniture joint”, U.S. Pat. No. 4,685,368 entitled “Band saw joint”, and U.S. Pat. No. 4,493,582 entitled “Tenon joint for wooden frames”.

These patents do not disclose any type of joint that relates to the present invention. The closest type of joint to the present invention is believed to be the dovetail joint. However, a dovetail joint has a contour that is trapezoidal in shape.

It is therefore an objective of the present invention to provide for a puzzle joint system for use in joining wood products such as chair and table components, and the like.

### SUMMARY OF THE INVENTION

The present invention provides for a joint system that may be used to join components, such as wood, and the like, to form a structural unit. An exemplary joint system comprises a first member having a predetermined shape, first and second opposed surfaces, and a first predetermined thickness. A cavity is formed in the first member that has a predetermined inner contour, that is exposed at the first surface of the first member and along a portion of an edge of the first member. The cavity has a depth that extends a predetermined distance below the first surface of the first member. A second member is provided that has a predetermined shape, first and second opposed surfaces, and a second predetermined thickness. The second member has a tab with an outer contour that substantially matches the inner contour of the cavity in the first member so that the tab fits within the cavity. The tab preferably a thickness that substantially matches the depth of the cavity. The inner and outer contours have a shape that is similar to a piece of a puzzle, a molar tooth, a dog bone, or a flattened (or portion of) a ball and socket, for example.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIGS. 1-3 illustrate three components of an exemplary frame structure employing a puzzle joint system in accordance with the principles of the present invention;

FIGS. 4-6 respectively illustrate top views of the components of the exemplary frame structure shown in FIGS. 1-3; and

FIGS. 7-9 respectively illustrate side views of the components of the exemplary frame structure shown in FIGS. 1-3.

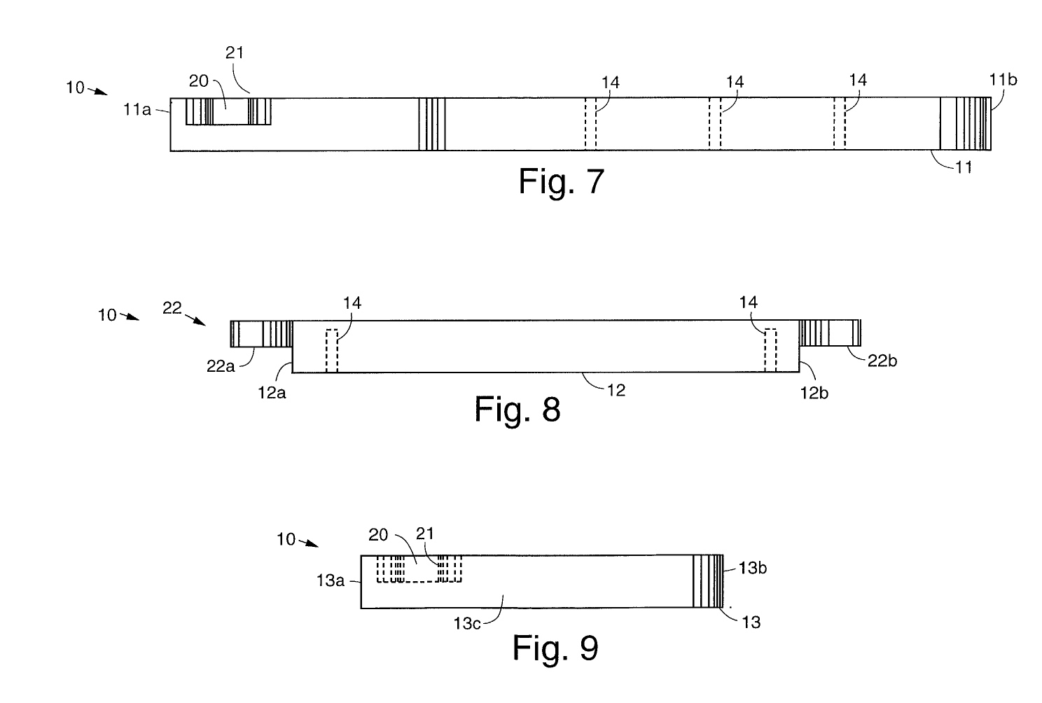

### DETAILED DESCRIPTION

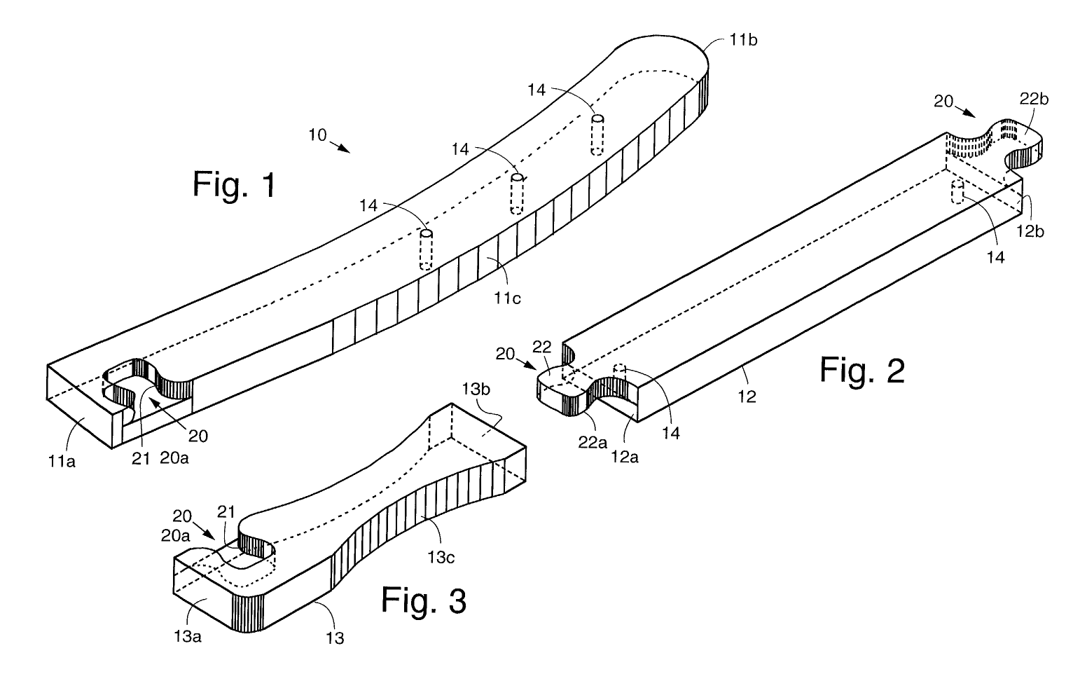

Referring to the drawing figures, FIGS. 1-3 illustrate three components of an exemplary frame structure 10 employing an exemplary puzzle joint system 20 in accordance with the principles of the present invention. The exemplary frame structure 10 is one side of a chair bucket to which cushions are fastened and on which a person sits. Two opposed frame structures 10 are attached using lateral supports (not shown) to form the chair bucket.

The exemplary frame structure 10 comprises a back support member 11 (FIG. 1), a lower support member 12 (FIG. 2), and a front support member 13 (FIG. 3). As is shown in FIG. 1, the back support member 11 comprises a flat curved wood piece having a flat lower end 11a, a rounded upper end 11b, and curved sides 11c. A plurality of holes 14 are drilled through the back support member 11 into which screws are disposed to secure lateral back supports (not shown).

A first portion of the exemplary puzzle joint system 20 is formed adjacent to the flat lower end 11a of the back support member 11. This portion of the puzzle joint system 20 comprises a cavity 20a or removed portion 20a or opening 20a of the back support member 11 whose sidewall 21 has a curvilinear shape in the form of a piece of a puzzle or a molar tooth, for example. The cavity 20a is formed to a depth that is about one-half of the thickness of the back support member 11. The shape of the cavity 20a is such that it forms an opening that is wide adjacent the side 11c of the back support member 11, relatively narrow near the middle of the cavity 20a, and wide past the middle of the cavity 20a. The back of the cavity 20a is flat in the exemplary embodiment. The sidewall 21 of the cavity 20a may also be considered to have an hour-glass shape, a dog bone shape, or a flat ball and socket shape, for example.

As is shown in FIG. 3, the front support member 13 comprises a flat partially curved wood piece that has a flat lower end 13a, a flat upper end 13b, and partially curved sides 13c. A second portion of the exemplary puzzle joint system 20 is formed adjacent to the flat lower end 13a of the front support member 13. The second portion of the exemplary puzzle joint system 20 is substantially the same as the first portion of the exemplary puzzle joint system 20 described above.

The second portion of the exemplary puzzle joint system 20 comprises a cavity 20a or removed portion 20a of the front support member 13 whose sidewall 21 has a curvilinear shape in the form of a piece of a puzzle or a molar tooth, for example. The cavity 20a is formed to a depth that is about one-half of the thickness of the front support member 13. The shape of the cavity 20a is such that it forms an opening that is wide adjacent the side 11c of the front support member 13, relatively narrow near the middle of the cavity 20a, and wide past the middle of the cavity 20a. The sidewall 21 of the cavity 20a may also be considered to have an hour-glass shape, a dog bone shape, or a flat ball and socket shape, for example.

As is shown in FIG. 2, the lower support member 12 comprises a flat rectangular wood piece having third portions of the exemplary puzzle joint system 20 formed at opposite ends 12a, 12b thereof. A plurality of holes 14 are drilled part way into the lower support member 12 into which threaded members are inserted and to which lateral seat supports (not shown) are secured. The respective opposite ends 12a, 12b of the lower support member 12 has a tab 22 whose external curvilinear shape substantially matches the shape of the respective cavities 20a formed in the back support member 11 and front support member 13.

The tabs 22 have a thickness that is about one-half of the thickness of the lower support member 12. The respective ends of the lower support member 12 are configured to have shapes that match the respective contours of the back support member 11 and front support member 13 adjacent to the respective cavities 20a. In the exemplary embodiment described herein, the shapes of the back and front support members 11, 13 adjacent to the respective cavities 20a are flat. However, it is to be understood that these areas may be shaped in any desired manner.

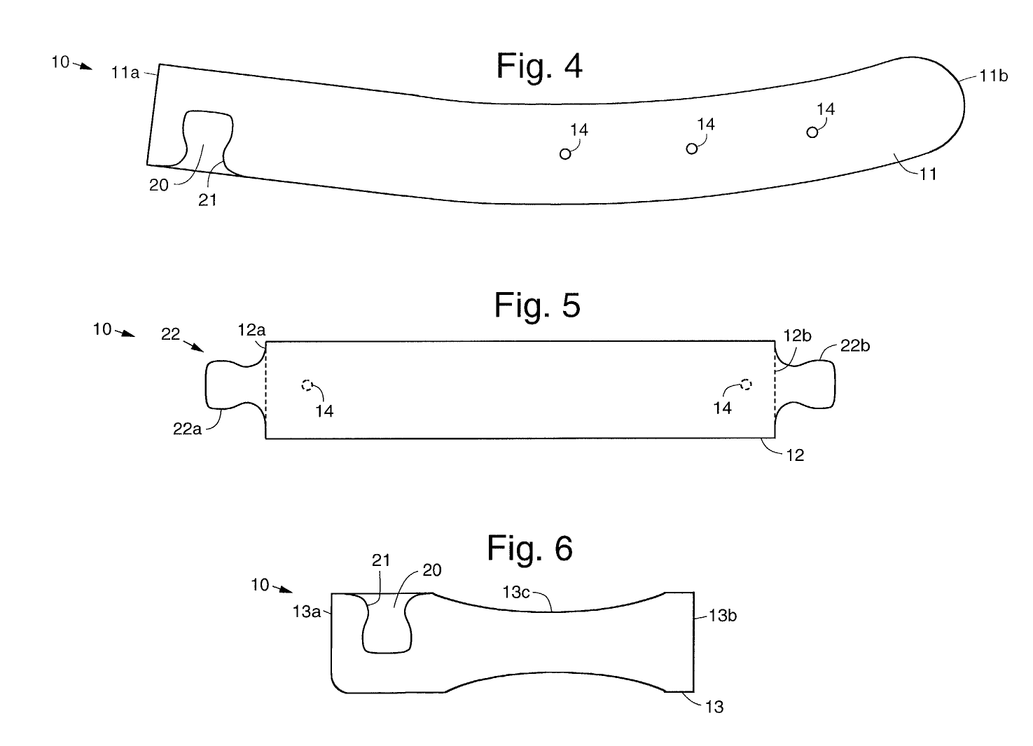

FIGS. 4-6 respectively illustrate top and side views of the back support member 11, lower support member 12, and front support member 13 used in the exemplary frame structure shown in FIGS. 1-3. Various contour lines are shown in the drawing figures that illustrate the curved nature of certain of the sidewalls 11c, 13c and ends 11b. 13b, and each of the cavities 20a and tabs 22 of the back, lateral and front support members 11, 12, 13.

Although not illustrated in the drawing figures, to assemble the components of the exemplary frame structure 10 using the exemplary puzzle joint system 20, the respective tabs 22 of the lower support member 12 are inserted into corresponding cavities 20a of the back and front support members 11, 13. The tabs 22 are glued into the cavities 20a to form each joint of the exemplary puzzle joint system 20.

It is to be understood that the puzzle joint system 20 need not have three components as is illustrated in the exemplary embodiment described above, and only two joined components are required. Accordingly, the present invention is not limited to the requirements of the specific embodiment described above.

It is also to be understood that the locations of the tabs 22 and cavities 20a of the puzzle joint system 20 may be interchanged if desired, in that tabs 22 may be formed at locations of the cavities 20a in the exemplary embodiment described above, and vice-versa. Thus, an improved puzzle joint system for use in joining wood components has been disclosed. It is to be understood that the above-described embodiment is merely illustrative of some of the many specific embodiments that represent applications of the principles of the present invention. Clearly, numerous and other arrangements can be readily devised by those skilled in the art without departing from the scope of the invention.

What is claimed is:

1. A joint system comprising:
a first member having a predetermined shape, first and second opposed surfaces, and a first predetermined thickness;
a cavity formed in the first member that has a predetermined inner partially curved contour, that is exposed at the first surface of the first member and along a portion of an edge of the first member, and that has a depth that extends a predetermined distance below the first surface, and wherein the depth of the cavity is a predetermined portion of the thickness of the first member; and
a second member having a predetermined shape, first and second opposed surfaces, and a second predetermined thickness, and having a tab with an outer partially curved contour that substantially matches the inner contour of the cavity in the first member so that the tab fits within the cavity, which tab a thickness that substantially matches the depth of the cavity formed in the first member.

2. The joint system recited in claim 1 wherein the thicknesses of the first and second members are substantially the same.

3. The joint system recited in claim 1 wherein the inner contour of the cavity and the outer contour of the tab are sized to allow a glue to be disposed therebetween.

4. The joint system recited in claim 1 wherein the inner partially curved contour of the cavity and the outer partially curved contour of the tab have the shape of a piece of a puzzle.

5. The joint system recited in claim 1 wherein the inner partially curved contour of the cavity and the outer partially curved contour of the tab have the shape of a molar tooth.

6. A joint system comprising:
a first member having a predetermined shape, first and second opposed surfaces, and a first predetermined thickness that comprises a cavity having a predetermined inner contour, that is exposed at the first surface, that is exposed along a portion of an edge of the first member, and that has a depth that extends a predetermined distance below the first surface; and
a second member having a predetermined shape, first and second opposed surfaces, and a second predetermined thickness, that comprises a tab with an outer contour that substantially matches the inner contour of the cavity and that fits within the cavity.

7. The joint system recited in claim 6 wherein the depth of the cavity and the thickness of the tab are substantially the same.

8. The joint system recited in claim 6 wherein the thicknesses of the first and second members are substantially the same.

9. The joint system recited in claim 6 wherein the inner contour of the cavity and the outer contour of the tab are sized to allow a glue to be disposed therebetween.

10. The joint system recited in claim 6 wherein the inner contour of the cavity and the outer contour of the tab have the shape of a piece of a puzzle.

11. The joint system recited in claim 6 wherein the inner contour of the cavity and the outer contour of the tab have the shape of a molar tooth.

12. A joint system comprising:
a first member having a predetermined shape, first and second opposed surfaces, and a first predetermined thickness that comprises a cavity having a predetermined inner partially curved contour, that is exposed at the first surface, that is exposed along a portion of an edge of the first member, and that has a depth that extends a predetermined distance below the first surface; and
a second member having a predetermined shape, first and second opposed surfaces, and a second predetermined thickness, that comprises a tab with an outer partially curved contour that substantially matches the inner partially curved contour of the cavity and that fits within the cavity.

13. The joint system recited in claim 12 wherein the depth of the cavity and the thickness of the tab are substantially the same.

14. The joint system recited in claim 12 wherein the thicknesses of the first and second members are substantially the same.

15. The joint system recited in claim 12 wherein the inner partially curved contour of the cavity and the outer partially curved contour of the tab are sized to allow a glue to be disposed therebetween.

16. The joint system recited in claim 12 wherein the inner partially curved contour of the cavity and the outer partially curved contour of the tab have the shape of a piece of a puzzle.

17. The joint system recited in claim 12 wherein the inner partially curved contour of the cavity and the outer partially curved contour of the tab have the shape of a molar tooth.
